(19) United States
(12) Patent Application Publication
(10) Pub. No.: US 2026/0362379 A1
(43) Pub. Date: Nov. 12, 2026

(54) A LOCATION MANAGEMENT FUNCTION (LMF) ARCHITECTURE AND A METHOD OF OPERATION OF THE SAME

(71) Applicant: JIO PLATFORMS LIMITED, Ahmedabad (IN)

(72) Inventors: Aayush BHATNAGAR, Navi Mumbai (IN); Vikash AGRAWAL, Navi Mumbai (IN); Omprakash KUSHWAH, Navi Mumbai (IN); Vikram LIMAN, Navi Mumbai (IN)

(73) Assignee: JIO PLATFORMS LIMITED, Ahmedabad (IN)

(21) Appl. No.: 19/515,169

(22) PCT Filed: Aug. 26, 2024
(86) PCT No.: PCT/IN2024/051558

§ 371 Date: Feb. 27, 2026

(30) Foreign Application Priority Data
Aug. 31, 2023 (IN) 202321058589

(51) Int. Cl. H04W 64/00; H04L 67/02

(52) U.S. Cl. CPC H04W 64/00; H04L 67/02

(57) ABSTRACT

The present disclosure relates to a location management function (LMF) architecture and a method of operation of the same. The present disclosure encompasses receiving, at a first module of a first LMF module, a request for positioning data of a user equipment (UE). The method further includes transmitting, by the first module of the first LMF module, to a first network function instruction to collect positioning data from the UE. The method further includes receiving, by the first module of the first LMF module, from the first network function. The method further includes computing, by the first LMF module, a position of the UE, based on the received positioning data. The method further includes transmitting, by the first module of the first LMF module, to second module of the LMF module. The method further includes transmitting, by the second module of the first LMF module, to a second network function.

### CROSS REFERENCE TO RELATED APPLICATIONS

This is the U.S. National Stage of International Application No. PCT/IN2024/051558, filed on Aug. 26, 2024, which was published in English under PCT Article 21(2), which in tum claims the benefit of India Application No. 202321058589, filed in India on Aug. 31, 2023. The applications are hereby incorporated herein in their entirety.

### FIELD OF TECHNOLOGY

The present disclosure generally relates to the field of wireless communication systems. More particularly, embodiment relates to a location management function (LMF) architecture and a method of operation of the same.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Wireless communication technology has rapidly evolved over the past few decades, with each generation bringing significant improvements and advancements. The first generation of wireless communication technology was based on analog technology and offered only voice services. However, with the advent of the second-generation (2G) technology, digital communication and data services became possible, and text messaging was introduced. The third-generation (3G) technology marked the introduction of high-speed internet access, mobile video calling, and location-based services. The fourth-generation (4G) technology revolutionized wireless communication with faster data speeds, better network coverage, and improved security. Currently, the fifth-generation (5G) technology is being deployed, promising even faster data speeds, low latency, and the ability to connect multiple devices simultaneously. With each generation, wireless communication technology has become more advanced, sophisticated, and capable of delivering more services to its users.

In 5G technology, location-based analysis of various network nodes is employed to leverage accurate location-awareness. In current existing solutions, Location Mobility Function (LMF) has functionality to support different interfaces to cater different types of services like, NL7 and NL1 interface. However, both the services are not highly dependent on each other hence, they are not tightly coupled to each other.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a location management function (LMF) architecture. The LMF may include a first LMF module. The first LMF module may include a first module and a second module. The first module may be configured to be connected to a first network function via a first interface. The second module may be configured to be connected to a second network function via a second interface. Further, the first module and the second module may be communicably coupled with each other via a third interface. Furthermore, the first module and the second module may exchange at least one of requests, and responses therebetween via the third interface.

In an exemplary aspect of the present disclosure, the communication via the third interface occurs through database (DB) streams.

In an exemplary aspect of the present disclosure, the first network function may be an access and mobility management function (AMF), and the second network function may be a second LMF module.

In an exemplary aspect of the present disclosure, the first interface is an NL1 interface, and the second interface is an NL7 interface.

In an exemplary aspect of the present disclosure, the communication via NL1 occurs via hypertext transfer protocol (HTTP).

Another aspect of the present disclosure may relate to a method of operation of a location management function (LMF) architecture. The method may include receiving, at a first module of a first LMF module, a request for positioning data of a user equipment (UE). The method further includes transmitting, by the first module of the first LMF module, to a first network function via a first interface, instruction to collect positioning data from the UE. The method further includes receiving, by the first module of the first LMF module via the first interface, from the first network function, positioning data related to the UE. The method further includes computing, by the first LMF module, a position of the UE, based on the received positioning data. The method further includes transmitting, by the first module of the first LMF module, to a second module of the LMF module, via a third interface, the position of the UE. The method further includes transmitting, by the second module of the first LMF module via a second interface, to a second network function, the position of the UE.

Yet another aspect of the present disclosure may relate to a non-transitory computer readable storage medium storing instructions for operation of a location management function (LMF) architecture, the instructions include executable code which, when executed, causes a first module of a first LMF module to receive a request for positioning data of a User Equipment (UE). Further, the instructions include executable code which, when executed causes the first module of the first LMF module to transmit, to a first network function via a first interface, instruction to collect positioning data from the UE. Further, the instructions include executable code which, when executed causes the first module of the first LMF module to receive, via the first interface from the first network function, positioning data related to the UE. Further, the instructions include executable code which, when executed causes the first LMF module to compute a position of the UE, based on the received positioning data. Further, the instructions include executable code which, when executed causes the first module of the first LMF module to transmit, to a second module of the first LMF module via a third interface, the position of the UE. Further, the instructions include executable code which, when executed causes the second module of the first LMF module to transmit, via a second interface to a second network function, the position of the UE.

### OBJECTS

Some of the objects of the present disclosure, which at least one embodiment disclosed herein satisfies are listed herein below.

It is an object of the present disclosure to provide a system and a method for operation of a location management function (LMF) architecture.

One primary object of the disclosure is implementing a micro-service architecture for catering one or more interfaces of Location Management Function (LMF).

Another object of the disclosure each separate micro-service node may cater respective service with independent load capacity without affecting the peer interface node.

### DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Also, the embodiments shown in the figures are not to be construed as limiting the disclosure, but the possible variants of the method and system according to the disclosure are illustrated herein to highlight the advantages of the disclosure. It will be appreciated by those skilled in the art that disclosure of such drawings includes disclosure of electrical components or circuitry commonly used to implement such components.

FIG. 1 illustrates an exemplary block diagram representation of 5^{th} generation core (5GC) network architecture.

FIG. 2 illustrates an exemplary block diagram of a location management function (LMF) architecture, in accordance with exemplary implementations of the present disclosure.

FIG. 3 illustrates a method flow diagram of operation of a location management function (LMF) architecture in accordance with exemplary implementations of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments. It will be apparent, however, that embodiments may be practiced without these specific details. Several features described hereafter may each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “including” as an open transition word-without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a Digital Signal Processing (DSP) core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface refers to a shared boundary across which two or more separate components of a system exchange information or data. The interface may also be referred to a set of rules or protocols that define communication or interaction of one or more modules or one or more units with each other, which also includes the methods, functions, or procedures that may be called.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

As used herein the transceiver unit include at least one receiver and at least one transmitter configured respectively for receiving and transmitting data, signals, information or a combination thereof between units/components within the system and/or connected with the system.

As discussed in the background section, the current existing solutions need to integrate heterogeneous interfaces, to empower a plethora of new services for 5G verticals and optimize the use of network resources. The present disclosure aims to overcome the above-mentioned and other existing problems in this field of technology by providing method and system of operation of a location management function (LMF) architecture.

The present disclosure aims to overcome the above-mentioned and other existing problems in this field of technology for implementing a micro-service architecture for catering one or more interfaces of LMF. The LMF have functionality to support different interfaces to cater different types of services like, NL7 and NL1 interface. Both the services are not highly dependent on each other hence it is not tightly coupled. Converting its architecture into micro services nodes may be beneficial of having advantages of micro services over monolithic architecture.

With the proposed solution, a microservice-based architecture may be implemented for the LMF node, whereby each separate micro-service node may cater respective service with independent load capacity without affecting the peer interface node.

Hereinafter, exemplary embodiments will be described with reference to the accompanying drawings.

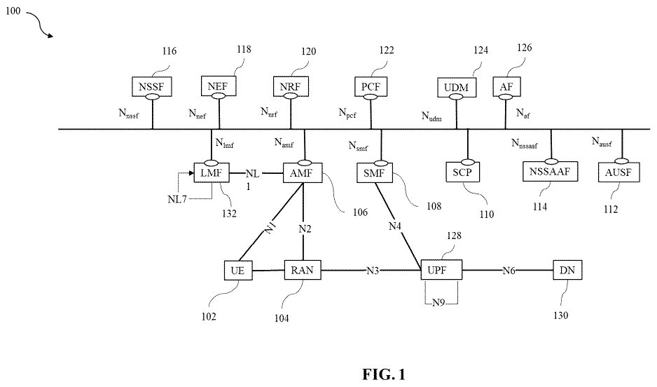

FIG. 1 illustrates an exemplary block diagram representation of 5^{th} generation core (5GC) network architecture, in accordance with exemplary implementation of the present disclosure. As shown in FIG. 1, the 5GC network architecture [100] includes a user equipment (UE) [102], a radio access network (RAN) [104], an access and mobility management function (AMF) [106], a Session Management Function (SMF) [108], a Service Communication Proxy (SCP) [110], an Authentication Server Function (AUSF) [112], a Network Slice Specific Authentication and Authorization Function (NSSAAF) [114], a Network Slice Selection Function (NSSF) [116], a Network Exposure Function (NEF) [118], a Network Repository Function (NRF) [120], a Policy Control Function (PCF) [122], a Unified Data Management (UDM) [124], an application function (AF) [126], a User Plane Function (UPF) [128], a data network (DN) [130] and Location Management Function (LMF) [132], wherein all the components are assumed to be connected to each other in a manner as obvious to the person skilled in the art for implementing features of the present disclosure.

Radio Access Network (RAN) [104] is the part of a mobile telecommunications system that connects user equipment (UE) [102] to the core network (CN) and provides access to different types of networks (e.g., 5G network). It consists of radio base stations and the radio access technologies that enable wireless communication.

Access and Mobility Management Function (AMF) [106] is a 5G core network function responsible for managing access and mobility aspects, such as UE registration, connection, and reachability. It also handles mobility management procedures like handovers and paging.

Session Management Function (SMF) [108] is a 5G core network function responsible for managing session-related aspects, such as establishing, modifying, and releasing sessions. It coordinates with the User Plane Function (UPF) for data forwarding and handles IP address allocation and QoS enforcement.

Service Communication Proxy (SCP) [110] is a network function in the 5G core network that facilitates communication between other network functions by providing a secure and efficient messaging service. It acts as a mediator for service-based interfaces.

Authentication Server Function (AUSF) [112] is a network function in the 5G core responsible for authenticating UEs during registration and providing security services. It generates and verifies authentication vectors and tokens.

Network Slice Specific Authentication and Authorization Function (NSSAAF) [114] is a network function that provides authentication and authorization services specific to network slices. It ensures that UEs can access only the slices for which they are authorized.

Network Slice Selection Function (NSSF) [116] is a network function responsible for selecting the appropriate network slice for a UE based on factors such as subscription, requested services, and network policies.

Network Exposure Function (NEF) [118] is a network function that exposes capabilities and services of the 5G network to external applications, enabling integration with third-party services and applications.

Network Repository Function (NRF) [120] is a network function that acts as a central repository for information about available network functions and services. It facilitates the discovery and dynamic registration of network functions.

Policy Control Function (PCF) [122] is a network function responsible for policy control decisions, such as QoS, charging, and access control, based on subscriber information and network policies.

Unified Data Management (UDM) [124] is a network function that centralizes the management of subscriber data, including authentication, authorization, and subscription information.

Application Function (AF) [126] is a network function that represents external applications interfacing with the 5G core network to access network capabilities and services.

User Plane Function (UPF) [128] is a network function responsible for handling user data traffic, including packet routing, forwarding, and QoS enforcement.

Data Network (DN) [130] refers to a network that provides data services to user equipment (UE) in a telecommunications system. The data services may include but are not limited to Internet services, private data network related services.

Location Management Function (LMF) [132] is a network entity in the 5G Core Network (5GC) responsible for managing the location information of user equipment (UE). It coordinates with other network functions to determine and provide the geographic location of a UE. It also obtains downlink location measurements or a location estimate from the UE.

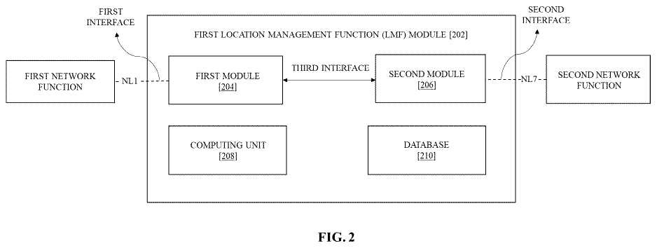

The Location Management Function (LMF) [132] is further illustrated in FIG. 2 as including various sub-modules and interfaces that enable it to communicate with other network functions.

FIG. 2, an exemplary block diagram of a location management function (LMF) architecture, is shown, in accordance with the exemplary implementations of the present disclosure.

The Location Management Function (LMF) architecture is structured around a modular design that facilitates efficient network management and communication within specific areas of the network. At its core, the LMF architecture includes a first LMF module [202], which is included of two primary sub-modules: the first module [204] and the second module [206].

The first module [204] within the LMF architecture is specifically configured to connect with a first network function via a first interface. In one example, the first network function may be an access and mobility management function (AMF). This connection is vital for enabling the LMF to interact with and manage the first network function, i.e., in one example, with the AMF, ensuring that necessary data may be exchanged. In another example, the first module [204] may be connected to the first network function via a NL1 interface. In yet another example, the communication via NL1 interface occurs via a hypertext transfer protocol (HTTP).

Similarly, the second module [206] is configured to connect with a second network function via a second interface. In one example, the second network function may be a second LMF module. This second interface allows the second module [306] to perform its role by communicating directly with the second network function, i.e., in one example, with the second LMF module, thus extending the reach and functionality of the LMF within the network. In another example, the second module [206] may be connected to the second network function via a NL7 interface.

The LMF offers to other NFs the following services:

Nlmf_Location: The NImf_Location service enables an NF to request location determination (current geodetic and optionally civic location) for a target UE or to request periodic or triggered location for a target UE.

Nlmf_Broadcast: The NImf_Broadcast service enables an NF to obtain ciphering keys and associated parameters applicable to location assistance data that is broadcast to subscribed UEs in ciphered form.

The Service provided by NL1: The NL1 interface may support location requests for a target UE sent from a serving AMF for the target UE to an LMF. Location requests may be supported for immediate location and for deferred location for periodic or triggered location events. The NL1 interface may also support the transfer from an LMF to an AMF of ciphering keys and associated data that enable deciphering by suitably subscribed UEs of ciphered broadcast assistance data.

The service provided by NL7: The NL7 interface may support location context transfer between two LMFs.

In an example, the computing unit [208] within the LMF architecture performs the computational tasks required for the operation of the LMF. It may handle processing operations such as managing the flow of information between the modules (first module [204] and second module [206]).

Further, the database [210] is a storage component within the LMF architecture that is used to store and manage data necessary for the functioning of the LMF. This data may include user equipment (UE) positioning information, network status data, and other relevant information needed for location management and network communication tasks.

Importantly, the first module [204] and the second module [206] are not isolated from one another; they are communicably coupled through a third interface. This third interface serves as a communication bridge between the two modules, allowing them to exchange requests, responses, or other necessary data. The ability for the first and second modules to interact via this third interface is important for the coordinated operation of the LMF, enabling it to manage localized network resources effectively by ensuring that both modules may work together, share information. In one example, the communication through the third interface may occur through Database (DB) streams.

In an example, ‘requests’ and ‘responses’ are standard procedures that represent a typical client-server or inter-module communication pattern.

Example of a Request: A request might involve the first module [204] initiating a query to the second module [206] for updated positioning data related to a specific user equipment (UE). This request would be transmitted via the third interface, prompting the second module to perform an operation such as retrieving the latest positioning data from a local database or cache.

Example of a Response: A response would be the second module [206] sending the requested positioning data back to the first module [204]. This could include the latest computed position of the UE or confirmation that the data retrieval operation was successfully completed. The response ensures that the first module [204] has the necessary data to proceed with further operations, such as transmitting the position to another network function.

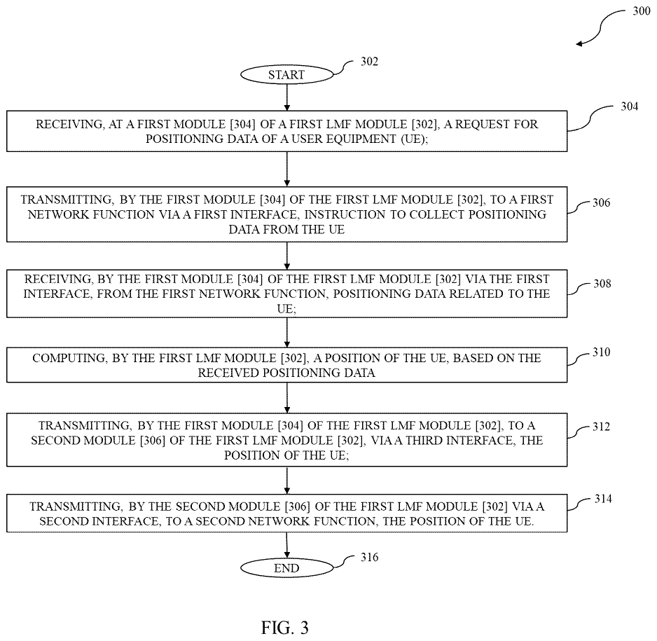

FIG. 3, an exemplary method flow diagram [300] of operation of a location management function (LMF) architecture, in accordance with exemplary implementations of the present disclosure is shown.

The method depicted in FIG. 3 outlines the process by which the LMF architecture handles the reception, processing, and transmission of positioning data for a user equipment (UE). Also, as shown in FIG. 3, the method [300] starts at step [302].

At step [304], the method includes, receiving, at a first module [204] of a first LMF module [202], a request for positioning data of a user equipment (UE).

In an implementation of the present disclosure, the first module [204] which is responsible for interacting with external network functions to collect the required data. The request is received by the first LMF module [202], which is responsible for managing the complete operation within the LMF architecture.

The positioning data refers to the information collected from the user equipment (UE) that is used to determine the UE's geographical location within the network. This data can include signals from various sources such as GPS, cell towers, Wi-Fi access points, or other sensors capable of providing location information.

At step [306], the method includes, transmitting, by the first module [204] of the first LMF module [202], to a first network function via a first interface, instruction to collect positioning data from the UE.

In one example, the first network function may be an access and mobility management function (AMF) and the first interface may be an NL1 interface.

In another example, communication via NL1 occurs via hypertext transfer protocol (HTTP).

At step [308], the method includes, receiving, by the first module [204] of the first LMF module [202] via the first interface, from the first network function, positioning data related to the UE.

In an implementation of the present disclosure, the first LMF module [202] utilizes algorithms and processing capabilities to determine the UE's location with precision. This position is important for subsequent operations that require accurate location information.

At step [310], the method includes, computing, by the first LMF module [302], a position of the UE, based on the received positioning data.

In an implementation of the present disclosure, the first LMF module [202] utilizes algorithms and processing capabilities to determine the UE's location with accuracy.

At step [312], the method includes, transmitting, by the first module [204] of the first LMF module [202], to a second module [206] of the first LMF module [202], via a third interface, the position of the UE.

In an implementation of the present disclosure, this step represents the internal communication within the LMF architecture. The third interface acts as the channel for this communication, ensuring that the position data is passed from the first module [204] to the second module [206]. This internal transfer is important for maintaining the flow of information within the LMF and preparing the data In one example, communication via the third interface occurs through database (DB) streams. The DB stream ensures transaction between the first module [204] and the second module [206].

The DB streams refer to a method of communication used for data exchange between the first module [204] and the second module [206]. The DB streams are real-time continuous flows of data that are transmitted between the modules, typically involving the exchange of database records or structured data packets. These streams allow for the efficient and consistent transfer of data, such as positioning records, between the modules. Further the DB streams capture changes to data, that involves a time-ordered sequence of item-level modifications. It may be event-driven stream that enable real-time data processing.

At step [314], the method includes, transmitting, by the second module [206] of the first LMF module [202] via a second interface, to a second network function, the position of the UE.

In one example, the second network function may be a second LMF module and the second interface may be an NL7 interface.

Thereafter, the method terminates at step [316].

The present disclosure further discloses a non-transitory computer readable storage medium storing instructions for operation of a location management function (LMF) architecture, the instructions include executable code which, when executed, causes a first module of a first LMF module to receive a request for positioning data of a User Equipment (UE). Further, the instructions include executable code which, when executed causes the first module of the first LMF module to transmit, to a first network function via a first interface, instruction to collect positioning data from the UE. Further, the instructions include executable code which, when executed causes the first module of the first LMF module to receive, via the first interface from the first network function, positioning data related to the UE. Further, the instructions include executable code which, when executed causes the first LMF module to compute a position of the UE, based on the received positioning data. Further, the instructions include executable code which, when executed causes the first module of the first LMF module to transmit, to a second module of the first LMF module via a third interface, the position of the UE. Further, the instructions include executable code which, when executed causes the second module of the first LMF module to transmit, via a second interface to a second network function, the position of the UE.

As is evident from the above, the present disclosure provides a technically advanced solution for operation of a location management function (LMF) architecture. The LMF have functionality to support different interfaces to cater different types of services like, NL7 and NL1 interface. Both the services are not highly dependent on each other hence it is not tight coupled. Converting its architecture into micro services nodes may be beneficial of having advantages of micro services over monolithic architecture.

While considerable emphasis has been placed herein on the disclosed implementations, it will be appreciated that many implementations can be made and that many changes can be made to the implementations without departing from the principles of the present disclosure. These and other changes in the implementations of the present disclosure will be apparent to those skilled in the art, whereby it is to be understood that the foregoing descriptive matter to be implemented is illustrative and non-limiting.

Further, in accordance with the present disclosure, it is to be acknowledged that the functionality described for the various components/units can be implemented interchangeably. While specific embodiments may disclose a particular functionality of these units for clarity, it is recognized that various configurations and combinations thereof are within the scope of the disclosure. The functionality of specific units as disclosed in the disclosure should not be construed as limiting the scope of the present disclosure. Consequently, alternative arrangements and substitutions of units, provided they achieve the intended functionality described herein, are considered to be encompassed within the scope of the present disclosure.

What is claimed is:

1. A location management function (LMF) architecture, comprising:
a first LMF module, comprising:
a first module configured to be connected to a first network function via a first interface; and
a second module configured to be connected to a second network function via a second interface,
wherein the first module and the second module are communicably coupled with each other via a third interface, and
wherein the first module and the second module exchange at least one of requests, and responses therebetween via the third interface.

2. The LMF architecture of claim 1, wherein the first module and the second module communicate via the third interface through database (DB) streams.

3. The LMF architecture of claim 1, wherein the first network function is an access and mobility management function (AMF), and the second network function is a second LMF module.

4. The LMF architecture of claim 1, wherein the first interface is an NL1 interface, and the second interface is an NL7 interface.

5. The LMF architecture of claim 4, wherein communication via NL1 occurs via hypertext transfer protocol (HTTP).

6. A method of operation of a location management function (LMF) architecture, the method comprising:
receiving, at a first module of a first LMF module, a request for positioning data of a user equipment (UE);
transmitting, by the first module of the first LMF module, to a first network function via a first interface, instruction to collect positioning data from the UE;
receiving, by the first module of the first LMF module via the first interface, from the first network function, positioning data related to the UE;
computing, by the first LMF module, a position of the UE, based on the received positioning data;
transmitting, by the first module of the first LMF module, to a second module of the first LMF module, via a third interface, the position of the UE; and
transmitting, by the second module of the first LMF module via a second interface, to a second network function, the position of the UE.

7. The method of claim 6, wherein communication via the third interface occurs through database (DB) streams.

8. The method of claim 6, wherein the first network function is an access and mobility management function (AMF), and the second network function is a second LMF module.

9. The method of claim 6, wherein the first interface is an NL1 interface, and the second interface is an NL7 interface.

10. The method of claim 9, wherein communication via NL1 occurs via hypertext transfer protocol (HTTP).

11. A non-transitory computer-readable storage medium storing instructions for operation of a location management function (LMF) architecture, the instructions comprising executable code which, when executed, causes:
a first module, of a first LMF module, to receive a request for positioning data of a user equipment (UE);
the first module of the first LMF module, to transmit, to a first network function via a first interface, instruction to collect positioning data from the UE;
the first module of the first LMF module, to receive, via the first interface, from the first network function, positioning data related to the UE;
the first LMF module to compute a position of the UE based on the received positioning data;
the first module of the first LMF module to transmit, to a second module of the first LMF module, via a third interface, the position of the UE; and
the second module of the first LMF module, to transmit, via a second interface, to a second network function, the position of the UE.
